(19) United States
(12) Patent Application Publication
(10) Pub. No.: US 2016/0314081 A1
(43) Pub. Date: Oct. 27, 2016

(54) STORAGE APPARATUS, CONTROLLER, AND DATA STORING METHOD

(71) Applicant: Kabushiki Kaisha Toshiba, Tokyo (JP)

(72) Inventors: Takashi Matsuo, Fujisawa Kanagawa (JP); Kenji Yoshida, Kamakura Kanagawa (JP)

(21) Appl. No.: 14/753,736

(22) Filed: Jun. 29, 2015

Related U.S. Application Data
(60) Provisional application No. 62/153,169, filed on Apr. 27, 2015.

(51) Int. Cl. G06F 12/14; H04L 29/06

(52) U.S. Cl. CPC G06F 12/1408; H04L 63/061; G06F 2212/1052

(57) ABSTRACT

According to one embodiment, a storage apparatus includes a recording medium configured to record encryption data, and a controller configured to acquire generation information of an encryption key used to encrypt the encryption data read from the recording medium, determine whether the acquired generation information is coincide with generation information of latest encryption key held beforehand, and write specific data different from the read encryption data into an area where the encryption data is recorded upon the acquired generation information being not coincide with the generation information of the latest encryption key.

### CROSS-REFERENCE TO RELATED APPLICATIONS

This application claims the benefit of U.S. Provisional Application No. 62/153,169, filed Apr. 27, 2015, the entire contents of which are incorporated herein by reference.

### FIELD

Embodiments described herein relate generally to a storage apparatus, controller, and a data storing method.

### BACKGROUND

In recent years, a data storage apparatus such as, for example, a disk drive or, more specifically, a magnetic disk drive is required to have an encryption function. A drive which has a data encryption (and decryption) function is also called a self-encrypting drive.

In the self-encrypting drive, an internal memory manages not only an encryption key used for encryption and decryption of data but also information which specifies the generation of the encryption key (sometimes referred to as “key generation information”). Based on the key generation information, encryption and decryption of data are performed using a latest encryption key currently in use (sometimes referred to as “newly encryption key”). A disk may contain not only data encrypted by the latest encryption key but also data encrypted by (a former generation of) encryption key which do not have the latest key generation information (sometimes referred to as “a former encryption key”). Therefore, in a case that the data encrypted with a former encryption key is decrypted with the latest encryption key, the data in that sector cannot be decrypted and thus is treated as invalid. Invalid data is respoded to a host device in a higher layer.

Not only encrypted data but also key generation information for specifying an encryption key used to encrypt the data is recorded on a disk in a unit of sector. Moreover, when encryption data and key generation information are recorded on the disk, each of them is coded in the unit of sector, and is added with a correction code. Therefore, in order to determine whether the encryption data recorded on the disk is encrypted with a former encryption key or a latest encryption key, it is necessary to decode the read data in the unit of sector using the correction code added to the read data, and to acquire key generation information.

### BRIEF DESCRIPTION OF THE DRAWINGS

FIG. 1 is an exemplary diagram showing an example of a data storage apparatus according town embodiment;

FIG. 2 is an exemplary diagram showing an example of a data structure according to the embodiment;

FIG. 3 is an exemplary diagram showing an example of another data structure according to the embodiment;

FIG. 4 is an exemplary diagram showing an example of a flowchart of data storing according to the embodiment; and

FIG. 5 is an exemplary diagram showing an example of a processing block to process specific pattern data according to the embodiment.

### DETAILED DESCRIPTION

Various embodiments will be described hereinafter with reference to the accompanying drawings.

In general, according to one embodiment, a storage apparatus comprises: a recording medium configured to record encryption data; and a controller configured to: acquire generation information of an encryption key used to encrypt the encryption data read from the recording medium; determine whether the acquired generation information is coincide with generation information of latest encryption key held beforehand; and write specific data different from the read encryption data into an area where the encryption data is recorded upon the acquired generation information being not coincide with the generation information of the latest encryption key.

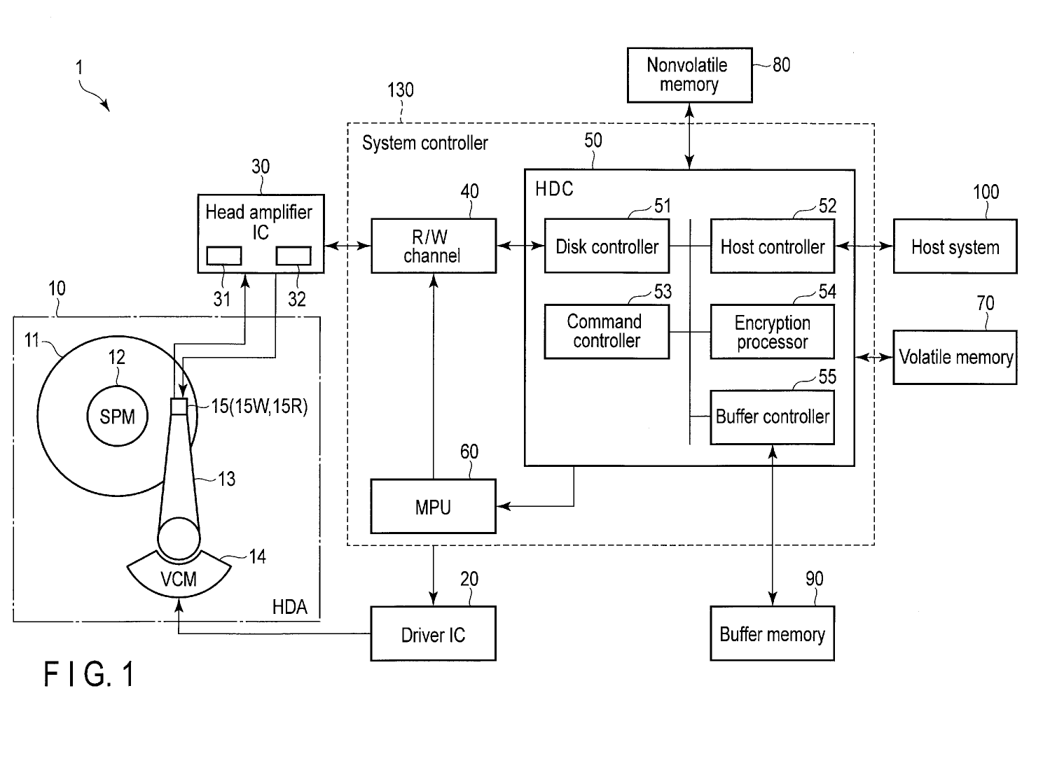

FIG. 1 illustrates an exemplary storage apparatus (disk drive) in an embodiment.

A disk drive, for example, a magnetic disk drive 1 includes a head-disk assembly (HDA) 10, a driver integrated circuit (hereinafter referred to as a “driver IC”) 20, a head amplifier integrated circuit (hereinafter referred to as a “head amplifier IC”) 30, a volatile memory 70, a nonvolatile memory 80, a buffer memory 90, and a system controller 130. The system controller 130 includes an R/W (read/write) channel 40, a hard disk controller (HDC) 50, and a microprocessor (MPU) 60. Moreover, the magnetic disk drive 1 connects with a host system (hereinafter referred to as a “host”) 100.

HDA 10 includes a magnetic disk (hereinafter referred to as a “disk”) 11, a spindle motor (SPM) 12, an arm 13 holding a head 15, and a voice coil motor (VCM) 14 which swings the arm 13. The disk 11 is rotated by the SPM 12. The arm 13 and the VCM 14 constitute an actuator. The actuator is driven by the VCM 14 and causes the head 15 held by the arm 13 to move in a radial direction of the disk 11 to a specified position over the recording surface of the disk 11. The disk drive 1 includes at least one disk and at least one head.

The head 15 includes a slider, a write (for writing) head 15W, and a read (for reading) head 15R. The write head 15W and the read head 15R are mounted on the slider. The read head 15R reads data currently recorded on data tracks of the recording surface of the disk 11. The write head 15W writes data in any data tracks of the recording surface of the disk 11.

The driver IC 20 controls drive of each of the SPM 12 and the VCM 14.

The head amplifier IC 30 includes a read amplifier 31 and a write driver 32. The read amplifier 31 amplifies a read signal read by the read head 15R, and inputs them into the R/W channel 40. The write driver 32 supplies a write current, which corresponds to write data output from the R/W channel 40, to the write head 15W.

The volatile memory 70 is a semiconductor memory which may lose its preserved data when power supply is shutdown. The volatile memory 70 holds data or the like required for processing in each part of the magnetic disk drive 1. The volatile memory 70 is a synchronous dynamic random access memory (SDRAM), for example.

The nonvolatile memory 80 is a semiconductor memory which keeps on holding the preserved data even after power supply has been shutdown. The nonvolatile memory 80 is a flash-read only memory (flash ROM), for example. The nonvolatile memory 80 preserves data which will be referred to at the time of data refresh (write back processing) in this embodiment.

The buffer memory 90 is a semiconductor memory which temporarily holds data or the like which will be transmitted and received between the disk 11 and the host system 100, or temporarily holds data read from the disk 11 for data refresh (until the read data will be written back again into the disk 11). It should be noted that the buffer memory 90 and the volatile memory 70 may be made for one piece. The buffer memory 90 includes, for example, a dynamic random access memory (DRAM), SDRAM, a ferroelectric random access memory (FeRAM) or a magnetoresistive random access memory (MRAM).

The R/W channel 40 (the system controller 130) performs signal processing for the read data (reading by the read head 15R) and for the write data writing by the write head 15W) of the head 15.

That is, the R/W channel 40 reproduces data from the read signal having been read from the disk 11 if the time of read processing (read operation), and changes data to the write signal to write the disk 11 at the time of write processing (write operation). Moreover, the R/W channel 40 performs ECC processing based on the ECC data concerning object data, at the time of data read operation or the time of data write operation.

The HDC 50 (the system controller 130) controls data transfer executed between the host system 100 and the R/W channel 40 according to the instructions from the MPU 60. The HDC 50 includes a disk controller 51, a host controller 52, a command controller 53, an encryption processor 54, and a buffer controller 55. In the present embodiment, all parts of the HDC 50 can be mutually connected by a bus or the like.

The disk controller 51 connects with the R/W channel 40, and controls the writing of data into the disk 11, the reading of data from the disk 11, etc.

The host controller 52 controls data transfer between the host system 100 and the host controller 52.

The command controller 53 performs control according to the write command or read command received from the host system 100.

The encryption processor 54 matches the latest encryption key (sometimes referred to as a “newly encryption key”, also) currently being used for encryption and decryption of data and the generation information (sometimes referred to as “key generation information”) of the newly encryption key, and manages them in an internal memory. The encryption processor 54 does not manage in the internal memory any encryption key whose key generation information is not the latest (that is, the key in question belongs to the former generation) (hereinafter also referred to as a “former encryption key”). Moreover, the encryption processor 54 performs data encryption processing or data decoding processing by using the newly encryption key managed in the internal memory.

The encryption processor 54 extracts key generation information, which is included in the read data, at the time of data read operation. The encryption processor 54 compares the extracted key generation information with the key generation information on the newly encryption key managed in the internal memory, and determines whether they are in agreement or not. Moreover, the encryption processor 54 adds key generation information to the data to be written at the time of data write operation. The key generation information may be added independently of the data to be written, or can be coded and embedded in a cyclic redundancy check (CRC) generated based on the data to be written.

Furthermore, when subjecting the data recorded on the disk 11 to the process of data refresh, the encryption processor 54 rewrites the data, which has been encrypted with the former encryption key and thus is invalid, into another data which is high in reproduction performance and is not easily brought into a deteriorated condition in terms of error rate, as will be described later. The data which is high in reproduction performance is data made from a specific pattern indicating that the data in question is encrypted by any of the former encryption keys (hereinafter referred to as “specific data”). Namely, what should be done is to acquire only key generation information from data which is recorded in a sector and belongs to a former key generation. The data itself recorded in the sector is unnecessary. For this reason, the specific data which can be stably read each time that read operation is executed will be written. This reduces read error in the read operation performed at the time of data refresh, and an improvement in error rate will be achieved.

The buffer controller 55 transmits data having been read from the disk 11 to the buffer memory 90 at the time of data refresh. The buffer controller 55 transmits to or reads from the buffer memory 90 data which should be supplied from the host system 100 and recorded on the disk 11 or data which should be read from the disk 11 and transmitted to the host system 100. That is, the buffer controller 55 performs control over the buffer memory 90 and data which should be transmitted or received. The buffer controller 55 performs transmission or reception of data to or from the buffer memory 90 based on, for example, the instructions from the MPU 60 or each part of the HDC 50 including the disk controller 51 or the encryption processor 54.

The MPU 60 (the system controller 130) controls each part of the magnetic disk drive 1. The MPU 60 performs, for example, servo control which controls the VCM 14 through the driver IC 20, or positions the head 15 to the disk 11. The MPU 60 controls the data read operation or data write operation of the disk 11.

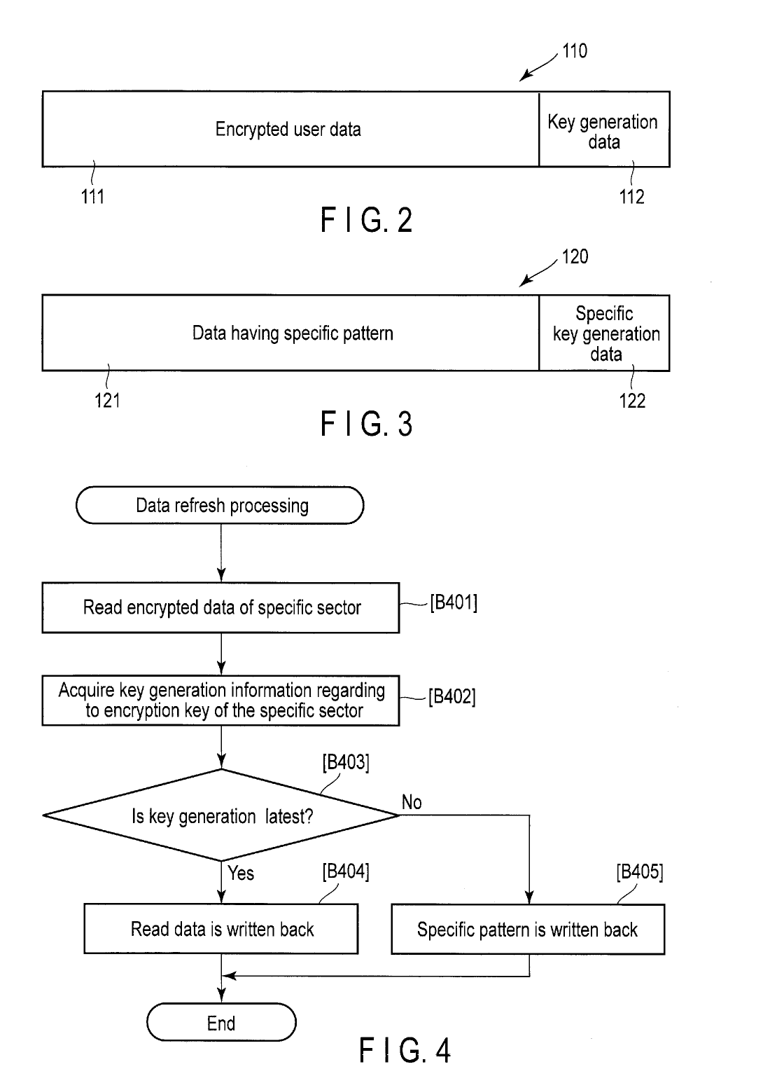

Now, an exemplary process of writing back data executed at the time of data refresh in this embodiment will be explained with reference to FIG. 2 and FIG. 3.

Data, which is on the disk 11 and should be subjected to data refresh, is first read from a track under the control of the MPU 60 (read operation is performed) at the time of the data refresh in this embodiment. In the read operation, the read head 15R is moved to an appointed track on the disk 11 (target for data refresh) by control of the disk controller 51 and the driver IC 20.

The R/W channel 40 decodes data based on the read signal output through the read head 15R (an ECC process may be included) and transmits the resultant data to the HDC 50. The HDC 50 processes data 110 by the sector, or by the unit of access, as illustrated in FIG. 2. The data 110 is recorded on one track by the unit of a plurality of sectors. Each unit of data 110 includes encrypted user data (hereafter also referred to as “encryption data”) 111 and a key generation data 112 indicative of key generation information. In addition to the encryption data 111 and the key generation data 112, it is possible to add a CRC which may be generated based on one or both of data 111 and 112. It is furthermore possible to arrange the key generation data 112 not in back of but in front or middle of the encryption data 111, and it is moreover possible to code the key generation data 112 and embed the coded key generation data 112 in the CRC which is based on the encryption data 111.

The encryption processor 54 in the HDC 50 compares the key generation information, which is included in the data 110 having been read from the track for refreshment, with the key generation information which the encryption processor 54 manages. The comparison between the former key generation information and the latter key generation information is made for every sector (for example, for every logical block address (LEA) assigned to the corresponding one of the sectors). The encryption processor 54 determines by this comparison whether the encryption key used when encrypting the encryption data 111 included in the read data 110 belongs to a newly encryption key. It is equivalent to the determination of whether the encryption data 111 included in the read data 110 is the data encrypted with a newly encryption key. The encryption processor 54 correlates the result of the determination with the sector number (the physical address or LBA on the disk 11) of the read data 110, and stores the correlation in the buffer memory 90. Moreover, the disk controller 51 stores into the buffer memory 90 a portion of the encryption data 111 that is encrypted with a newly encryption key among the encryption data 111 included in the read data 110.

Here, in the event that the internal memory which keeps the key generation information is a volatile memory, the encryption processor 54 manages the key generation information, which is kept by the internal memory, also using a nonvolatile storage section, such as a system area prepared in the disk 11 or in the nonvolatile memory 80. In such a case, it is possible for the encryption processor 54 to store in the buffer memory 90 instead of the internal memory the key generation information read from the nonvolatile storage section.

Next, the data that is based on the data 110 read from the track for data refresh and should be write back is written to the track for data refresh under the control of the MPU 60 (a rewrite operation is performed). In this rewrite operation, the write head 15W is moved to an appointed track (target for data refresh) on the disk 11 by the control of the disk controller 51 and the driver IC 20.

The buffer controller 55 reads from the encryption data 111 kept in the buffer memory 90 based on the sector number and the determination result, both being stored in the buffer memory 90, a portion of the encryption data 111 having been encrypted with the newly encryption key. The read encryption data 111 is transmitted through the disk controller 51 to the R/W channel 40. The R/W channel 40 codes the transmitted encryption data 111, and writes back this coded data back to the track for data refresh under the control of the disk controller 51 and the driver IC 20.

The HDC 50 specifies based on the determination result and the sector number, both being stored in the buffer memory 90, a sector that holds a portion of the encryption data 111 having been encrypted with not a newly encryption key but a former encryption key. Specific data 121 such as illustrated in FIG. 3 is prepared as data which should be written back to the specific sector in place of the encryption data 111 which has been recorded on the specific sector and which has been encrypted with a former encryption key. The specific data 121 is such data that is dependent on a data pattern in terms of error correction performance and thus is high in terms of correction performance.

That is, the specific data 121 made of a data pattern that will be stably read. The specific data 121 may be data that is not encrypted. Moreover, the buffer controller 55 adds specific key generation data 122 to the specific data 121. The specific key generation data 122 indicating that the data having been recorded on the specified sector is the data 111 encrypted with a former encryption key. In addition, it is possible to add besides the specific data 121 and the specific key generation data 122 a CRC which may be generated based on one or both of them. Furthermore, it is possible to arrange the specific key generation data 112 not in back of but in front or middle of the specific data 121, and it is moreover possible to code the specific key generation data 112 and embed the coded specific key generation data 112 in the CRC which is based on the specific data 121.

The written back data 120 including the specific data 121 and the specific key generation data 122 is prepared in this way. The prepared written back data 120 is transmitted through the disk controller 51 to the R/W channel 40. The R/W channel 40 codes the transmitted written back data 120 (the ECC processing may be included), and writes back this coded data on the track which is a target of data refresh under the control of the disk controller 51 and the driver IC 20.

Thus, in the write operation executed in the data refresh process, the specific key generation data 122 and the specific data 121 which is high in reproduction performance are written to the sector on which the data 111 encrypted with the former encryption key was recorded. This makes it possible to read data and key generation information in a state of low error rates. Therefore, the disk drive as a whole will be improved in error rate.

FIG. 4 illustrates the procedure of data refresh process in this embodiment.

First, the HDC 50 reads the encryption data of the specified sector, and stores (buffers) it in the predetermined region of the buffer memory 90 ([B401]).

Next, the HDC 50 acquires key generation information added to the data read (buffered) from the sector ([B402]), and determines whether or not the acquired key generation information is the latest (or corresponds to a newly encryption key) ([B403]).

In the event that the acquired key generation information is the latest ([B403-YES]), the HDC 50 writes to the original sector (track) the data that is held in the buffered sector ([B404]).

In the event that the acquired key generation information is not the latest (or does not correspond to a newly encryption key) ([B403-NO]), the HDC 50 writes to the original sector (track) the written back data 120 which includes the specific key generation data 122 and specific data that is high in reproduction performance unlike the original user data ([B405]). In addition, it is also possible in the block [B405] not to change key generation information but only to write specific data in the original sector. Furthermore, it is possible that the procedure illustrated in FIG. 4 will be executed not by hardware such as the HDC 50 but by firmware including the MPU 60.

Therefore, whether the key applied to the data in the sector belongs to the latest key generation or not can be determined only by reading the key generation information whenever the write back process is executed on and after next time. Moreover, since specific data high in reproduction performance and different from the original user data is read, the error rate of the data refresh carried out to a user data area can be reduced. That is, in the case of data which is encrypted with a former encryption key and is invalid, it will be detected at a low error rate that a key generation is not the latest. A drive device as a whole will improve in error rate.

Now, an example of specific data high in reproduction performance will be explained below.

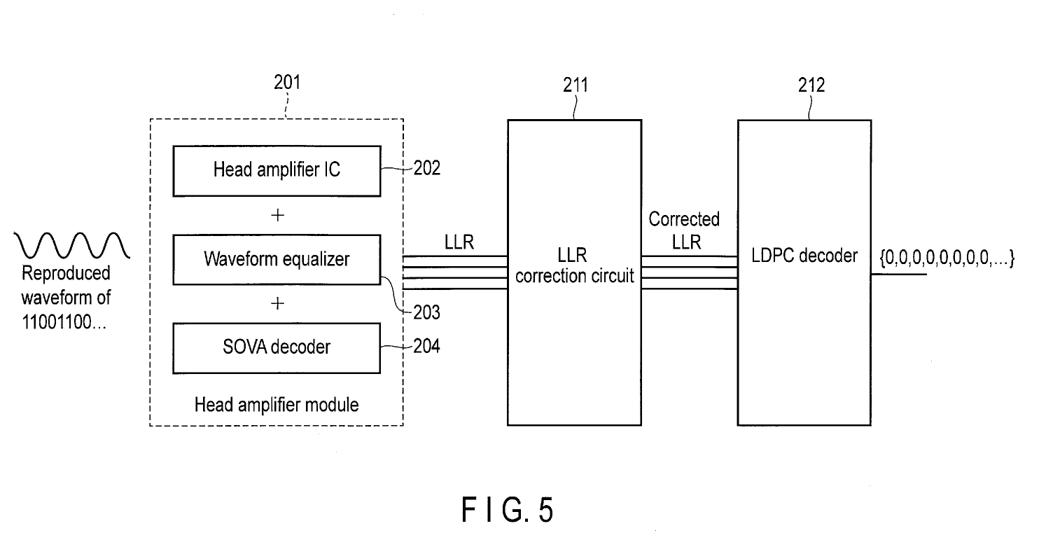

The specific data includes high in reproduction performance is a pattern which shows high reproducibility when it is read at the time of data refresh. For example, arbitrary numbers of data patterns are prepared. Each data pattern is encoded with various encoding systems. A specific data pattern that is actually low in erroneously read rate is determined out of all the encoded data patterns. What follows are criteria for specifying data pattern that is low in erroneously read rate. Specific data patterns low in erroneously read rate may be determined based on one of the number of times of transition occurrence, the number of times of successive transitions, and their increase or decrease tendencies, for example. It is possible to change the identification of the “0” and “1” of a record reproduction series of determined data pattern by an LLR correction circuit shown in FIG. 5 in order to obtain correct codes at the time of read.

That is, specific data is determined in the following way:

(1) Generate random data pattern for the amount of one sector;

(2) Record the generated data pattern after encode on the disk 11;

(3) Perform a read process of the recorded data patterns for the amount of one sector;

(4) Measure an error rate and

(5) Repeat (1)-(4) for a prescribed number of times, for example, some hundreds of times, and then select a data pattern which is the lowest in error rate.

Furthermore, a data pattern which can be specified by the code recognition technology disclosed in the registered patent (Japanese Patent No. 5275423) invented by the inventor of this application may be used as specific data.

FIG. 5 exemplarily illustrates a logarithmic likelihood ratio (LLR) correction circuit which the above mentioned Japanese Patent No. 5275423 discloses in FIG. 2. In FIG. 5, in a head amplifier part 201 containing head amplifier IC 202, a waveform equalizer 203 and the SOVA decoder 204.

As shown in FIG. 5, the logarithmic likelihood ratio (LLR) which indicates the soft determination result input from a SOVA decoder 204 is corrected by an LLR correction circuit 211 to a logarithmic likelihood ratio which indicates linear codes and can be decoded by an LDPC decoder 212. The soft determination result input from the SOVA decoder 204 is amplified reproduction waveform inputted into a head amplifier 202 of a head amplifier module 201 and equalized by a waveform equalizer 203 of the head amplifier module 201. In this way, 2T patterns are obtained and are written to the sector on which invalid data encrypted by a former encryption key of the disk 11 is recorded.

The LLR correction circuit 211 corrects and outputs a group of soft determination values concerning the bit information input from the SOVA decoder 204 using a rule (pattern) with “reverse, reverse, not change, not change.” The LLR values output by this operation are wholly set to 0, i.e., the codes of the LLR may become a repetition of “negative, negative, negative, negative” in the event that there is no error that is “positive, positive, negative, negative” are in an input pattern.

This operation makes it possible to cause the LDPC decoder 212, which decodes the LLR output from the LLR correction circuit 211, to output as a decoding result an all zero code word which includes 0's in the event that there is no error in an input pattern. Moreover, in a case where such an error that the LDPC decoder 212 can correct exists in an input pattern, the LDPC decoder 212 will correct the error when it decodes the input pattern, and thus an all zero code word will be obtained as a decoding result.

As has been explained above, specific key generation information will be read in this embodiment when a process of writing back data that is in a sector whose key generation information indicates that the sector does not belong to the latest key generation will be executed on and after the next time, it will be possible to specify that the sector does not belong to the latest key generation. Moreover, since specific data which is different from user data and is high in reproduction performance will be read in a user data area, user data which should be reproduced (decrypted) will be easily identified. Therefore, data refresh (process to white back) with few error rates will be achieved. That is, in the case of data which is encrypted with a former encryption key and is invalid, it will be detected at a low error rate that a key generation is not the latest, as explained above. Therefore, a drive device as a whole will improve in error rate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage apparatus comprising:
a recording medium configured to record encryption data; and
a controller configured to:
acquire generation information of an encryption key used to encrypt the encryption data read from the recording medium;
determine whether the acquired generation information is coincide with generation information of latest encryption key held beforehand; and
write specific data different from the read encryption data into an area where the encryption data is recorded upon the acquired generation information being not coincide with the generation information of the latest encryption key.

2. The storage apparatus of claim 1, wherein the specific data comprises a data pattern allowing stable reading in a reading process.

3. The storage apparatus of claim 1, wherein the specific data comprises key generation information indicative of a specific generation and different from the generation information of the latest encryption key.

4. The storage apparatus of claim 2, wherein the specific data comprises key generation information indicative of a specific generation and different from the generation information of the latest encryption key.

5. The storage apparatus of claim 1, wherein the specific data is unencrypted data.

6. The storage apparatus of claim 2, wherein the specific data is unencrypted data.

7. A controller comprising:
an acquisition module configured to acquire generation information of an encryption key used upon encrypting input encryption data;
a determination module configured to determine whether the acquired generation information is coincide with generation information of latest encryption key held beforehand;
a generation module configured to generate specific data different from the input encryption data when the acquired generation information is not coincide with the generation information one of the latest encryption key; and
a coding circuit configured to code the generated specific data.

8. The controller of claim 7, wherein the specific data comprises a data pattern allowing stable reading in a reading process.

9. The controller apparatus of claim 7, wherein
the specific data comprises key generation information indicative of a specific generation and different from the generation information of the latest encryption key.

10. The controller of claim 8, wherein the specific data comprises key generation information indicative of a specific generation and different from the generation information of the latest encryption key.

11. The controller of claim 7, wherein the specific data is unencrypted data.

12. The controller of claim 8, wherein the specific data is unencrypted data.

13. A method for data storing comprising:
acquiring generation information of an encryption key used to encrypt encryption data read from a recording medium;
determining whether the acquired generation information is coincide with generation information of latest encryption key held beforehand; and
writing specific data different from the read encryption data into an area where the encryption data is recorded upon the acquired generation information being not coincide with the generation information of the latest encryption key.

14. The method of claim 13, wherein the specific data comprises a data pattern allowing stable reading.

15. The method of claim 13, wherein the specific data comprises key generation information indicative of a specific generation and different from the generation information of the latest encryption key.

16. The method of claim 14, wherein the specific data comprises key generation information indicative of a specific generation and different from the generation information of the latest encryption key.

17. The method of claim 13, wherein the specific data is unencrypted data.

18. The method of claim 14, wherein the specific data is unencrypted data.
